(19) United States
(12) Patent Application Publication
(10) Pub. No.: US 2016/0035144 A1
(43) Pub. Date: Feb. 4, 2016

(54) SUPPLEMENTING COMPACT IN-VEHICLE INFORMATION DISPLAYS

(71) Applicant: GM Global Technology Operations LLC, Detroit, MI (US)

(72) Inventors: Satheesh Adimoolam, Vellore (IN); Jagadish Ramanjaneya, Chitradurga (IN)

(21) Appl. No.: 14/447,108

(22) Filed: Jul. 30, 2014

(51) Int. Cl. G07C 5/00; G09G 5/00; G06K 9/18; B60K 35/00

(52) U.S. Cl. CPC G07C 5/00; G07C 5/008; B60K 35/00; G09G 5/003; G06K 9/18

(57) ABSTRACT

A system and method of supplementing a compact in-vehicle information display using a handheld wireless device includes: receiving at the handheld wireless device a vehicle code that is generated by a vehicle and shown on the compact in-vehicle information display; automatically accessing a look-up table using the handheld wireless device and the vehicle code; identifying the vehicle code shown on the compact in-vehicle information display in the look-up table; obtaining an explanation of the vehicle code from the look-up table using the handheld device; and presenting the explanation via the handheld wireless device.

### TECHNICAL FIELD

The present invention relates to compact in-vehicle displays and, more particularly, to the use of hand-held wireless devices to augment the compact in-vehicle displays.

### BACKGROUND

Vehicles include the ability to monitor the functionality of a wide array of systems on board the vehicle. Vehicle systems modules can receive data from one or more sensors and based on that data determined if some aspect of vehicle functionality falls outside of established parameters that indicate normal vehicle operation. When this occurs, the vehicle can alert vehicle occupants that one or more vehicle functions may not be functioning optimally. Some vehicles may be equipped with a larger display that can be used to present the vehicle occupant with a comprehensive set of information relating to the vehicle functions in need of attention. However, many vehicles include only compact displays that can convey small amounts of information and may not adequately explain abnormal vehicle functions. These vehicles may continue to use in-vehicle compact displays for a variety of reasons, such as cost or simplicity. As a result, it can be helpful to provide vehicle occupants using a compact in-vehicle display additional information.

### SUMMARY

According to an embodiment of the invention, there is provided a method of supplementing a compact in-vehicle information display using a handheld wireless device. The method includes receiving at the handheld wireless device a vehicle code that is generated by a vehicle and shown on the compact in-vehicle information display; automatically accessing a look-up table using the handheld wireless device and the vehicle code; identifying the vehicle code shown on the compact in-vehicle information display in the look-up table; obtaining an explanation of the vehicle code from the look-up table using the handheld device; and presenting the explanation via the handheld wireless device.

According to an embodiment of the invention, there is provided a method of supplementing a compact in-vehicle information display using a handheld wireless device. The method includes capturing an image of a vehicle code shown on the compact in-vehicle information display using a camera included with the handheld wireless device; identifying the vehicle code from the image captured by the handheld wireless device; comparing the vehicle code shown on the compact in-vehicle information with entries in a look-up table; obtaining an explanation of the vehicle code from the look-up table; and presenting the explanation via the handheld wireless device.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein; and

FIG. 2 is a flow chart depicting an embodiment of a method of supplementing a compact in-vehicle information display using a handheld wireless device.

### DETAILED DESCRIPTION OF THE ILLUSTRATED EMBODIMENT(S)

The system and method described below uses a handheld wireless device to augment the limited amount of information provided by a compact in-vehicle information display. Compact in-vehicle information displays can include segmented visual displays or small-sized text-only visual displays that can convey only a limited amount of information to a driver or vehicle occupant. For example, when a vehicle detects an abnormal vehicle condition, it may generate a two or three-digit code on a segmented display. This two-digit code may be of little meaning to a vehicle occupant. However, the code can be used to unlock much more detailed information about the underlying vehicle condition. In another example, when the vehicle is equipped with a small-sized text-only visual display, the display may not be large enough to convey information about the abnormal vehicle condition to a vehicle occupant. The small size of the visual display may be a further hindrance to display languages other than English, such as Korean or German, which can consume more space to display words describing vehicle conditions. And even if the condition could be displayed on the small-sized display, the vehicle occupant may need to scroll the text across the display, which is frequently contrary to local laws. To compensate for the small size of the screen, the vehicle may convey vehicle conditions in a short-hand or code that may not be readily understandable by vehicle occupants.

However, vehicle occupants often carry handheld devices, such as a smart phone. The handheld wireless devices carried by vehicle occupants can be used to translate the codes or limited information shown on the small-sized display into much more detailed information than would be possible to be shown in the vehicle. The handheld wireless device can receive vehicle identifiers, such as the manufacturer, year, and model name of the vehicle. The code displayed by the vehicle can then be provided to the handheld wireless device, which searches for information associated with the code based on the vehicle identifiers. The handheld wireless device, using information stored locally or obtained from a remote facility, can provide more detailed information or explanations about the displayed code(s) via the handheld wireless device. The displays of handheld wireless devices may be more sophisticated and/or larger in relation to the small-sized display of the vehicle. The greater sophistication and size of the handheld wireless device display can permit more complex and more voluminous text display, audio output, and even video that provides information regarding the vehicle condition than would be possible with the compact in-vehicle displays used.

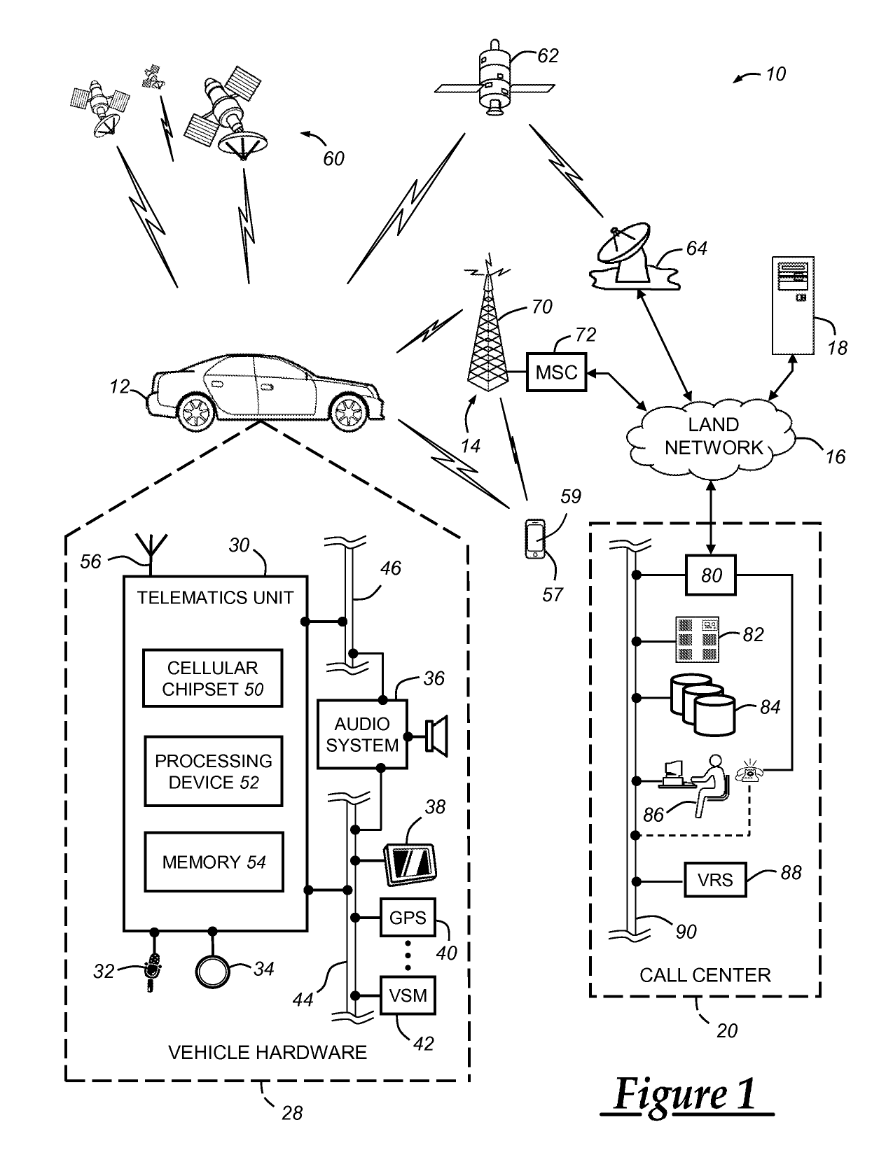

With reference to FIG. 1, there is shown an operating environment that comprises a mobile vehicle communications system 10 and that can be used to implement the method disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. The visual display 38 may also be referred to as a compact in-vehicle information display and will be described in more detail below. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that is installed in the vehicle and that enables wireless voice and/or data communication over wireless carrier system 14 and via wireless networking. This enables the vehicle to communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM or CDMA standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, such as any of the IEEE 802.11 protocols, WiMAX, or Bluetooth. When used for packet-switched data communication such as TCP/IP, the telematics unit can be configured with a static IP address or can set up to automatically receive an assigned IP address from another device on the network such as a router or from a network address server.

One of the networked devices that can communicate with the telematics unit 30 is a handheld wireless device, such as a smart phone 57. The smart phone 57 can include computer processing capability, a transceiver capable of communicating using a short-range wireless protocol, and a visual smart phone display 59. In some implementations, the smart phone display 59 includes a touch-screen graphical user interface. Examples of the smart phone 57 include the iPhone™ manufactured by Apple, Inc. While the smart phone 57 may include the ability to communicate via cellular communications using the wireless carrier system 14, this is not always the case. For instance, Apple manufactures devices such as the various models of the iPad™ and iPod Touch™ that include the processing capability, the display 59, and the ability to communicate over a short-range wireless communication link. However, the iPod Touch™ and some iPads™ do not have cellular communication capabilities. Even so, these and other similar devices may be used or considered a type of handheld wireless device, such as the smart phone 57, for the purposes of the method described herein.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

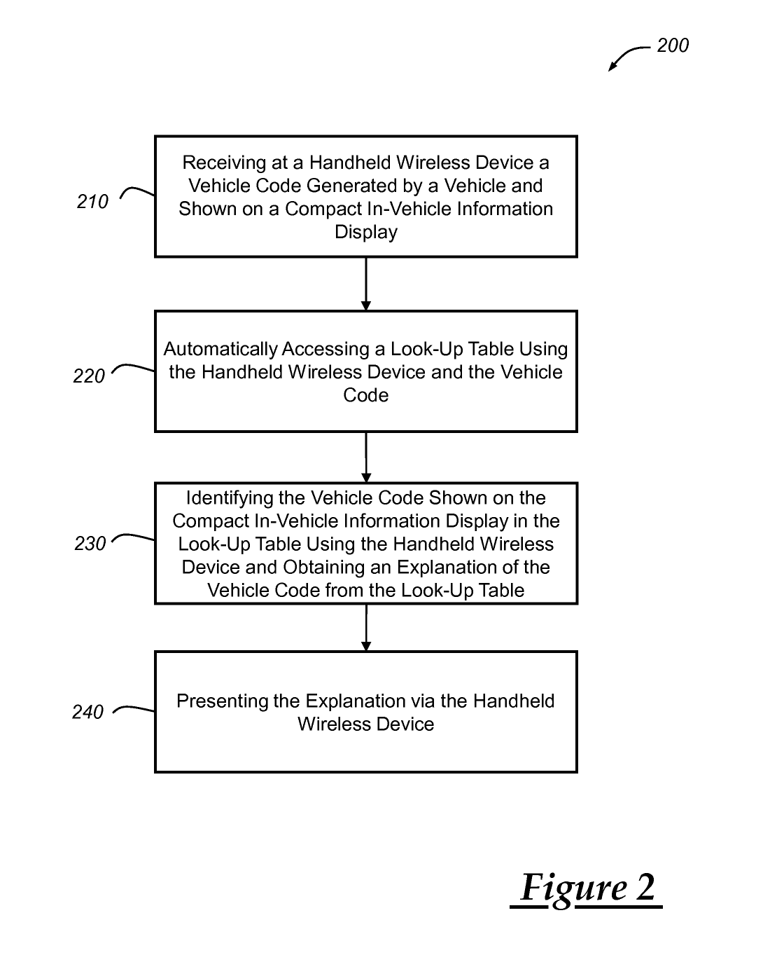

Turning now to FIG. 2, there is shown a method 200 of supplementing a compact in-vehicle information display using a handheld wireless device. The method 200 begins at step 210 by receiving at the handheld wireless device a vehicle code that is generated by the vehicle 12 and shown on the compact in-vehicle information display. As the vehicle 12 is operated, the driver or other vehicle occupant can receive information about the condition of the vehicle 12 through the compact in-vehicle information display. This information is often conveyed in a short-hand notation in the form of a vehicle code that represents an underlying vehicle condition. For example, the compact in-vehicle display may show the driver or vehicle occupant the vehicle code as the number “91.” To a vehicle occupant, the number “91” may have no meaning or no relationship to a vehicle condition. However, the number “91” could be associated with and describe a vehicle condition, such as the absence of a wireless key fob in the vehicle 12. Or in another example, the compact in-vehicle display could show “LF 28” to the driver or vehicle occupant. Again, this message may not have any meaning to a vehicle occupant. But “LF 28” can be used to indicate that the left front tire of the vehicle has a low pressure condition and has been measured to be 28 pounds-per-square inch (PSI).

The compact in-vehicle information displays can be implemented in a number of ways but generally are limited by the complexity and/or amount of information the displays can provide. For example, the compact in-vehicle information display can solely include segmented displays. Unlike more complex displays, the segmented displays typically provide numerical information but can be used to display limited amounts of alphabetic characters or vertical stacks of bars that can convey fluid or temperature levels. As can be appreciated, the displays can show numbers like “91” or combinations of letters and numbers, such as “LF 28.” Each segmented display may be able to show one digit or alphabetic character. The segmented display can be implemented as seven, nine, fourteen, or sixteen segment displays. While the handheld wireless device in method 200 will be described in terms of the smart phone 57, it should be appreciated that other types of handheld wireless devices could be successfully substituted for the smart phone 57 to carry out method 200.

In one implementation, the smart phone 57 can capture an image of a vehicle code shown on the compact in-vehicle information display using a camera included with the smart phone 57. The vehicle code can then be identified from the image captured. The smart phone 57—as can be appreciated from smart phone examples identified above—includes a camera that may be used by a vehicle occupant to photograph the vehicle code shown on the compact in-vehicle information display. When the vehicle code appears on the display, the vehicle occupant can aim the camera toward the display and capture an image or photograph of the vehicle code. Using a software application that can process photographs to identify letters and numbers, the smart phone 57 can extract the vehicle code from the photograph or image and convert it to data representing vehicle code.

In other implementations, the vehicle code can be manually reported or conveyed to the smart phone 57 by the vehicle occupant. For instance, the vehicle occupant can visually read the vehicle code from the compact in-vehicle information display and then enter the numbers and/or letters into a keyboard or keypad of the smart phone 57. It is also possible for a vehicle occupant to verbally recite the vehicle code from the display and, using automatic speech recognition (ASR) provided by the smart phone 57, convert the recited vehicle code to data. The method 200 proceeds to step 220.

At step 220, a look-up table is automatically accessed using the smart phone 57 and the vehicle code. Once the vehicle code has been obtained by the smart phone 57, it can attempt to locate the vehicle code in a look-up table or a database that associated one or more vehicle codes with an explanation of an underlying vehicle condition associated with each vehicle code. The look-up table can be “automatically accessed” in the sense that the smart phone 57 can search the table and access data contained in the table without human interaction. The look-up table can be individualized for each vehicle model and year that the vehicle 12 was produced. In one implementation, the look-up table can include a plurality of vehicle codes each of which is associated with a more detailed text-based explanation of the vehicle code. For example, the vehicle code “91” discussed above can be associated with an explanation that the code reflects the absence of a key fob from the vehicle 12. Apart from an explanation of the cause of the code, the explanation can also include steps that a vehicle occupant can take that fixes the problem. With respect to the example of code “91,” the explanation can remind the vehicle occupant to place the key fob inside of the vehicle 12 or replace the batteries that power the key fob. In addition or instead of text, the explanation can include audio and/or video explanations of the underlying vehicle condition the vehicle code describes.

The vehicle owner or vehicle occupant can enter the model year and model name of the vehicle 12 into the smart phone 57, which can use the model year and model name to access an appropriate database. For example, the vehicle 12 may be a 2014 Chevrolet Cruze and the vehicle occupant can enter “2014,” “Chevrolet,” and “Cruze” via an alphanumeric keypad on the smart phone 57. The smart phone 57 can then access an appropriate look-up table or an appropriate portion of the look-up table that pertains to the model and model year of the vehicle 12. In this example, the vehicle occupant may access explanations associated with the vehicle codes that are generated by a 2014 Chevrolet Cruze by identifying the model and model year of the vehicle 12. The vehicle codes for one model of vehicle 12 be associated with different explanations than other model years. Thus, it can be helpful to identify the vehicle 12 that has generated the vehicle code.

It is possible to store the look-up table locally at the smart phone 57 such that the smart phone 57 can access its own memory device to search for explanations of vehicle conditions associated with vehicle codes. However, in some embodiments the look-up table can be maintained at a remote facility, such as the computer 18 shown in FIG. 1. In that case, the smart phone 57 can then wirelessly transmit the vehicle code to the central facility where the look-up table is located. The processing carried out to identify explanations associated with the vehicle code that was sent can take place at the remote facility. The explanations identified as part of this searching can then be wirelessly transmitted to the smart phone 57 from the remote facility. The method 200 proceeds to step 230.

At step 230, the vehicle code shown on the compact in-vehicle information display is identified in the look-up table using the smart phone 57 and an explanation of the vehicle code is obtained from the look-up table. The vehicle code generated by the vehicle 12 and obtained by the smart phone 57 can be compared to the plurality of vehicle codes included in the look-up table. When a match is found between the vehicle code generated by the vehicle 12 and one of the codes in the look-up table, any explanations that have been associated or stored with the matching vehicle code can be accessed by the smart phone 57. It is also possible to convert explanations associated with vehicle codes in the look-up table from one language to another. For example, the explanation of code “91” can be text-based and written in English. However, the smart phone 57 may be setup to use a language other than English. In that case, the smart phone 57 can translate the text-based explanation into the language understood by user of the smart phone 57. The method 200 proceeds to step 240.

At step 240, the explanation is presented via a display on the smart phone 57. After obtaining the explanation associated with the vehicle code displayed by the vehicle 12, the smart phone 57 can present the explanation to the driver or vehicle occupant via text, audio, video, or any combination of these. For example, the explanation can be presented on the smart phone display 59 as text. Or in another example, the explanation can be played via a speaker of the smart phone 57 apart from or in addition to the displayed text. The explanations could also be shown as video on the smart phone display 59. The method 200 then ends.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of supplementing a compact in-vehicle information display using a handheld wireless device, comprising the steps of:
(a) obtaining at the handheld wireless device an alphanumeric vehicle code that is generated by a vehicle and shown on the compact in-vehicle information display, wherein the alphanumeric vehicle code is obtained via a photograph captured by the handheld wireless device or obtained via manual input from a user;
(b) automatically accessing a look-up table using the handheld wireless device and the vehicle code;
(c) identifying the vehicle code shown on the compact in-vehicle information display in the look-up table;
(d) obtaining an explanation of the vehicle code from the look-up table using the handheld device; and
(e) presenting the explanation via the handheld wireless device.

2. The method of claim 1, wherein the handheld wireless device further comprises a smart phone.

3. The method of claim 1, further comprising the step of accessing the look-up table at a remote facility.

4. The method of claim 1, further comprising the step of accessing the look-up table from a memory device located on the handheld wireless device.

5. The method of claim 1, further comprising the step of translating the explanation from one language to another language.

6. The method of claim 1, wherein the compact in-vehicle information display further comprises one or more segmented displays.

7. (canceled)

8. (canceled)

9. A method of supplementing a compact in-vehicle information display using a handheld wireless device, comprising the steps of:
(a) capturing an image of an alphanumeric vehicle code shown on the compact in-vehicle information display using a camera included with the handheld wireless device;
(b) identifying the vehicle code from the image captured by the handheld wireless device;
(c) comparing the vehicle code shown on the compact in-vehicle information with entries in a look-up table;
(d) obtaining an explanation of the vehicle code from the look-up table; and
(e) presenting the explanation via the handheld wireless device.

10. The method of claim 9, wherein the handheld wireless device further comprises a smart phone.

11. The method of claim 9, further comprising the step of accessing the look-up table at a remote facility.

12. The method of claim 9, further comprising the step of accessing the look-up table from a memory device located on the handheld wireless device.

13. The method of claim 9, further comprising the step of translating the explanation from one language to another language.

14. The method of claim 9, wherein the compact in-vehicle information display further comprises one or more segmented displays.
